(19) United States
(12) Patent Application Publication
(10) Pub. No.: US 2026/0230369 A1
(43) Pub. Date: Aug. 6, 2026

(54) Managing Network Devices

(71) Applicant: Mellanox Technologies, Ltd., Yokneam (IL)

(72) Inventors: Ayal Lior, Kiryat Ono (IL); Alex Netes, Rehovot (IL); Ortal Bashan, Tel Aviv (IL); Rafi Ram, Herzeliya (IL)

(21) Appl. No.: 19/045,583

(22) Filed: Feb. 5, 2025

(51) Int. Cl. H04L 41/0213; H04L 41/082

(52) U.S. Cl. CPC H04L 41/0213; H04L 41/082

(57) ABSTRACT

A network-device management apparatus includes a network interface and a processor. The network interface is to communicate with a first network of a first network protocol, wherein the first network is to manage a second network of a second network protocol that is different from the first network protocol. The processor is to run a Network Operating System (NOS) that jointly manages network devices in both the first network and the second network.

### TECHNICAL FIELD

The present disclosure relates generally to management of communication networks, and particularly to methods and systems for managing networks of different network protocols and technologies.

### BACKGROUND

A Network Operating System (NOS) is an operating system that manages one or more network devices, such as switches or routers, in a communication network. Example NOS functions include network device configuration, telemetry and troubleshooting, lifecycle management, redundancy and failover, and others.

### SUMMARY

An embodiment that is described herein provides a network-device management apparatus including a network interface and a processor. The network interface is to communicate with a first network of a first network protocol, wherein the first network is to manage a second network of a second network protocol that is different from the first network protocol. The processor is to run a Network Operating System (NOS) that jointly manages network devices in both the first network and the second network.

In some embodiments, as part of running the NOS, the processor is to (i) run an Application Programming Interface (API) for managing the second network, (ii) receive, via the API, a management command specified in terms of the second network or the second network protocol, and (iii) execute the management command in the second network via the first network. In example embodiments, the API hides a presence of the first network, even though the NOS manages network devices in both the first network and the second network.

In a disclosed embodiment, the processor is to translate the management command into (i) one or more first operations to be performed in one or more first network devices in the first network, and (ii) one or more second operations to be performed in the one or more second network devices in the second network, and to perform the one or more first operations and the one or more second operations.

In an example embodiment, the management command includes a configuration command for configuring one or more second network devices in the second network, and, in response to the configuration command, the processor is to configure the one or more second network devices in the second network, and to also configure one or more first network devices in the first network.

In another embodiment, the management command includes an update command, for updating software in one or more network devices in the second network, and the processor is to update the software in the second network, while maintaining compatibility between the updated software and the first network.

In yet another embodiment, the management command refers to one or more network devices in the second network in terms of one or more second identifiers or addresses of the second network protocol, and the processor is to (i) map the one or more second identifiers or addresses to at least one first identifier or address of the first network protocol, and (ii) route the management command via the first network using the at least one first identifier or address.

In a disclosed embodiment, in response to addition of a new network device to the second network, the processor is to reconfigure the first network to forward traffic to the new network device. In another embodiment, the processor is to run, as part of the NOS, (i) one or more first containers associated with the first network protocol, and (ii) one or more second containers associated with the second network protocol. In various embodiments, the network devices include switches and/or routers.

There is additionally provided, in accordance with an embodiment that is described herein, a network-device management method. The method includes communicating with a first network of a first network protocol, wherein the first network is to manage a second network of a second network protocol that is different from the first network protocol, and running a Network Operating System (NOS) that jointly manages network devices in both the first network and the second network.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a computing system comprising an operational network and a management network, in accordance with an embodiment that is described herein;

FIG. 2 is a flow chart that schematically illustrates a method for managing network devices in an operational network, via a management network, using a single NOS, in accordance with an embodiment that is described herein; and

FIG. 3 is a block diagram that schematically illustrates a computing system having network devices that may be managed via a management network using a single NOS, in accordance with an embodiment that is described herein.

### DETAILED DESCRIPTION OF EMBODIMENTS

### Overview

A conventional Network Operating System (NOS) is capable of managing a single network device, or a group of network devices that operate in accordance with a given network protocol. In the present context, the term “network protocol” (also referred to as “network technology”) refers to, for example, Ethernet or InfiniBand™ (IB). The term “network device” refers to devices that process packets in a communication network, such as switches and routers.

In various practical scenarios, however, a communication system comprises network devices of different network protocols, and there is considerable value in managing them jointly.

Consider, for example, a number of IB switches that are aggregated, for management purposes, by an Ethernet switch and connected to a management node. A larger configuration may comprise an IB network comprising multiple IB switches, which are connected to a management node via an Ethernet network comprising multiple Ethernet switches. It is possible in principle to manage the IB switches using one NOS, and manage the Ethernet switches using a separate NOS. This sort of solution, however, is cumbersome, inefficient and prone to configuration errors.

Embodiments that are described herein provide improved methods and apparatus for joint management of network devices of different network protocols. In some disclosed embodiments, a management node is connected to a first network (e.g., an Ethernet network) that is in turn connected to a second network (e.g., an IB network), wherein the first network manages the second network. The first (e.g., Ethernet) network is also referred to herein as a management network, and the second (e.g., IB) network is also referred to herein as an operational network. The management node runs a multi-network-protocol NOS instance that jointly manages network devices in both the first network and the second network.

The embodiments described herein refer mainly to IB and Ethernet, purely by way of example. The disclosed techniques can be used with any other suitable network protocols, e.g., Nvlink, UAlink, Wi-Fi, and others.

In some embodiments, the disclosed NOS runs an Application Programming Interface (API) that enables applications to manage network devices in the IB network, while hiding the presence of the Ethernet network from the applications. Toward the management applications, the disclosed NOS mimics an IB-only NOS. Back-end processing in the NOS, however, manages network devices in both networks.

In an example embodiment, the NOS receives management commands from one or more applications via the API. The management commands are specified in IB terms, e.g., specify network devices in the IB network using IB identifiers or addresses (e.g., Local Identifiers—LIDs). Nevertheless, complete and consistent execution of the management commands typically requires performing certain operations in the Ethernet network, as well.

For example, reconfiguring switches in the IB network may require reconfiguration of switches in the Ethernet network, as well. As another example, updating software in IB switches may call for a corresponding update in the Ethernet switches to maintain system-wide compatibility.

Thus, in some embodiments, the disclosed NOS translates a given management command into (i) one or more operations to be performed in one or more IB network devices of the IB network, and (ii) one or more operations to be performed in one or more Ethernet network devices of the Ethernet network. The NOS performs the operations in the two networks. Various demonstrative use cases of this technique are described below.

When using the disclosed NOS, management applications and their users are provided with a unified interface for management tasks such as network-device configuration, monitoring and lifecycle management, even though the underlying management operations affect network devices of different networks and network protocols. Management applications typically issue management commands for the IB network devices, unaware of the fact that these commands also trigger operations in the Ethernet network.

### System Description

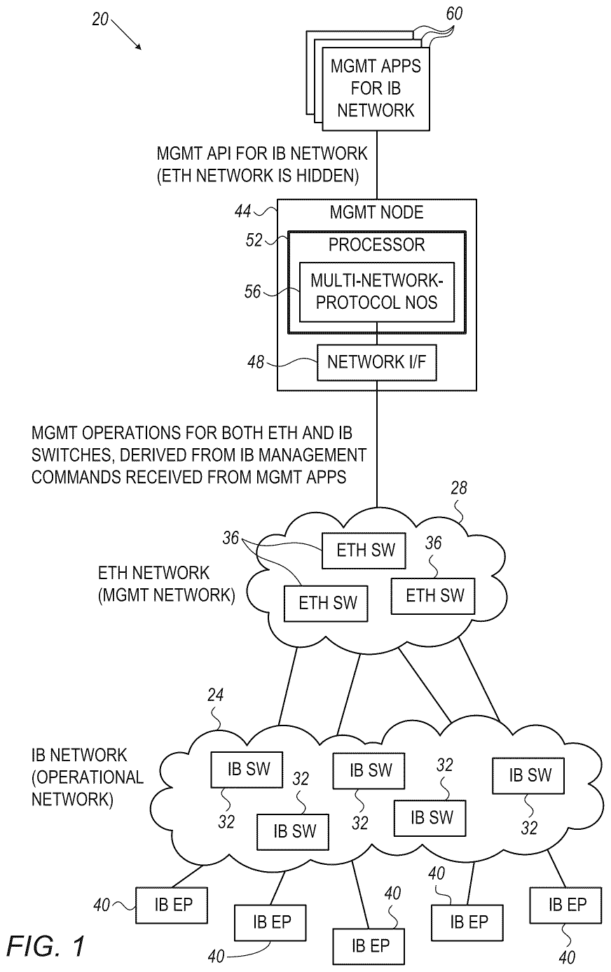

FIG. 1 is a block diagram that schematically illustrates a computing system 20, in accordance with an embodiment that is described herein. System 20 comprises two communication networks—an InfiniBand (IB) network 24 and an Ethernet network 28. IB network 24 comprises one or more IB switches 32. Ethernet network 28 comprises one or more Ethernet switches 36.

IB network 24 serves multiple IB endpoints (IB EPs) 40 to carry out some designated function, e.g., a data center or a High-Performance Computing (HPC) cluster. IB endpoints 40 may comprise, for example, servers, Graphics Processing Units (GPUs), or any other suitable type of endpoint. Ethernet network 28 is used for managing IB switches 32 of IB network 24. As such, IB network 24 is also referred to as a functional network, and Ethernet network 28 is referred to as a management network. More generally, the disclosed techniques are not limited to the use-case of a management network. For example, network 28 may comprise an access network used by a CPU to reach functional network 24.

System 20 further comprises a network-device management node 44 that jointly manages IB switches 32 and Ethernet switches 36. As seen in FIG. 1, management node 44 is connected to Ethernet network 28. Node 44 manages IB switches 32 via Ethernet network 28, i.e., by communicating via one or more Ethernet switches 36.

Management node 44 comprises a network interface 48, e.g., an Ethernet Network Interface Controller (NIC), for connecting to Ethernet network 28. Node 44 further comprises a processor 52 that carries out the various processing tasks of the management node. Processor 52 runs a multi-protocol NOS 56, also referred to as a NOS instance, which jointly manages IB switches 32 and Ethernet switches 36, using methods that are described in detail below.

The configurations of system 20 and its components, e.g., management node 44, as depicted in FIG. 1, are example configurations that are chosen purely for the sake of conceptual clarity. Any other suitable configurations can be used in alternative embodiments.

For example, in the embodiment of FIG. 1 Ethernet network 28 has no Ethernet endpoints. In alternative embodiments, one or more suitable Ethernet endpoints, e.g., an Ethernet network management server, may be connected to any of switches 36. As another example, in the embodiment of FIG. 1 Ethernet network 28 is connected to IB network 24 using multiple network links. This configuration is useful, for example, for fanning-out the traffic between networks 24 and 28, for load balancing and resilience. In alternative embodiments, networks 24 and 28 may be connected by a single link. Each of networks 24 and 28 may comprise any suitable number of switches or other network devices, even a single network device.

In one example implementation, NOS 56 comprises one or more containers associated with IB network 24, and one or more separate containers associated with Ethernet network 28. The former containers may run, for example, IB drivers, APIs and/or Software Development Kits (SDKs). The latter containers may run, for example, Ethernet drivers, APIs and/or SDKs. In alternative embodiments, NOS 56 may be implemented in any other suitable way.

In various embodiments, management node 44 may be implemented using suitable software, using suitable hardware such as one or more Application-Specific Integrated Circuits (ASIC) or Field-Programmable Gate Arrays (FPGA), or using a combination of hardware and software. In some embodiments, processor 46 of management node 44 is implemented using one more general-purpose processors, which are programmed in software to carry out the techniques described herein. The software may be downloaded to the processors in electronic form, over a network, for example, or it may, alternatively or additionally, be provided and/or stored on non-transitory tangible media, such as magnetic, optical, or electronic memory.

### Joint Management of Network Devices of Different Network Protocols/Technologies

In some embodiments, one or more management applications 60 run over NOS 56 of management node 44. A given management application 60 may run on processor 56 of node 44. Alternatively, a given management application 60 may run on a different computer connected to node 44. Among other tasks, processor 56 runs an API that is used by management applications 60 for managing IB switches 32 of IB network 24.

As noted above, execution of a management command issued by an application 60 typically requires performing certain operations in Ethernet switches 36, in addition to the requested operations in IB switches 32. In this respect, NOS 56 plays a dual role:
Toward applications 60, NOS 56 operates similarly to an IB-only NOS. To this end, the API exposed by NOS 56 hides the presence of Ethernet network 28 from applications 60. Applications 60 issue management commands that are expressed in terms of IB, e.g., refer to IB switches 32 using IB identifiers or addresses (e.g., LIDs).
Toward networks 24 and 28, NOS 56 translates the management commands into (i) operations that are executed in IB switches 32, and (ii) operations that are executed in Ethernet switches 36. NOS 56 may also perform address/identifier translations or mappings that enable routing management commands via the Ethernet network to the appropriate destinations in the IB network.

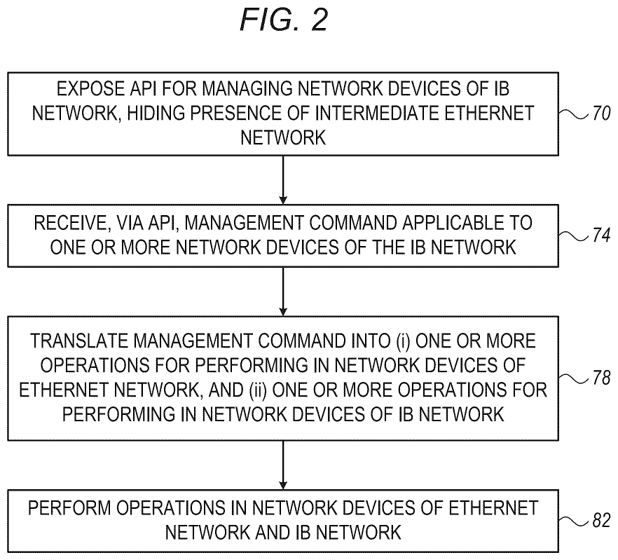

FIG. 2 is a flow chart that schematically illustrates a method for managing IB switches 32 of IB network 24 via Ethernet network 28, in accordance with an embodiment that is described herein. The method begins with NOS 56 of management node 44 running a management API that is accessible to management applications 60, at an API exposing stage 70.

At a command receiving stage 74, NOS 56 receives a management command from a certain management application 60 via the API. At a translation stage 78, NOS 56 translates the management command into (i) one or more operations to be performed in one or more IB switches 32 of IB network 24, and (ii) one or more operations to be performed in one or more Ethernet switches 36 of Ethernet network 28. At a command execution stage 82, NOS 56 executes the above operations in Ethernet switches 36 and IB switches 32.

The flow of FIG. 2 is a simplified example flow that is chosen purely for the sake of conceptual clarity. In alternative embodiments, NOS 56 may use any other suitable flow.

### Example Management Commands and Use-Cases

The management commands that NOS 56 receives from applications 60 may be of various types. Management commands may comprise, for example, commands for reconfiguring an IB switch or a group of IB switches, commands for updating software in an IB switch or a group of IB switches, commands for requesting telemetry from an IB switch or a group of IB switches, commands that set-up or activate fail-over redundancy between IB switches, and others. Each type of management command may require, in addition to the requested operation(s) in IB switches 32, one or more operations in Ethernet switches 36. Depending on the type of management command, NOS 56 translates the management command into the appropriate operations in both IB switches 32 and Ethernet switches 36.

One general type of translation has to do with mapping of addresses or identifiers. A management command received from an application 60 is typically addressed to one or more IB switches 32. The command typically specifies a given IB switch in terms of an IB identifier or address, e.g., LID, to which the command is to be sent. In order to reach the IB switch, however, node 44 should route the command correctly via Ethernet network 28. In some embodiments, NOS 56 holds a mapping that specifies, for each IB identifier or address (e.g., LID), a corresponding Ethernet identifier or address (e.g., destination MAC address or VLAN tag) via which the IB identifier is reachable. NOS 56 forwards management commands to IB switches 32 via Ethernet network 28, by addressing the commands to the appropriate Ethernet identifiers or addresses, in accordance with the mapping.

In an example implementation, a given IB switch 32 comprises an Ethernet port that is connected to Ethernet network 28. The IB switch receives packets addressed to the switch's Medium Access Control (MAC) Destination Address (DA). This mechanism also enables forwarding packets via one IB switch 32 to another IB switch 32. Processor 52 directs packets to a specific IB switch 32 using a VLAN tag, which is used by Ethernet network 28 for forwarding. The Ethernet switch that forwards the packets to IB network 24 typically removes the VLAN tag on egress.

In some embodiments, when a management command is addressed to a group of IB switches, NOS 56 uses the mapping to define an Ethernet multicast group comprising the Ethernet identifiers or addresses via which the IB switches in the group are reachable. NOS 56 then forwards the command, and possibly subsequent commands to the same group of IB switches, by sending multicast packets to the multicast group.

In some embodiments, NOS 56 receives from an application 60 a management command that requests reconfiguration of one or more IB switches 32. In some cases, reconfiguring an IB switch 32 requires reconfiguration of one or more Ethernet switches 36, as well. For example, adding a new IB switch 32 to network 24 requires configuring one or more of Ethernet switches 36 with suitable forwarding information, so that traffic will be forwarded via Ethernet network 28 to/from the new IB switch.

In some embodiments, NOS 56 receives from an application 60 a management command that requests performing a software update in one or more IB switches 32. In the present context, the term “software” also include firmware. In some cases, updating software in one or more IB switches 32 necessitates a corresponding update (software update and/or parameter reconfiguration) in one or more Ethernet switches 36, e.g., to maintain

compatibility between the IB and Ethernet switches. In some embodiments, in response to a software update command from an application 60, NOS 56 (i) performs the requested software update in one or more IB switches 32, and (ii) determines and performs the appropriate updates in one or more IB switches 36 to maintain compatibility.

### Example Operational System

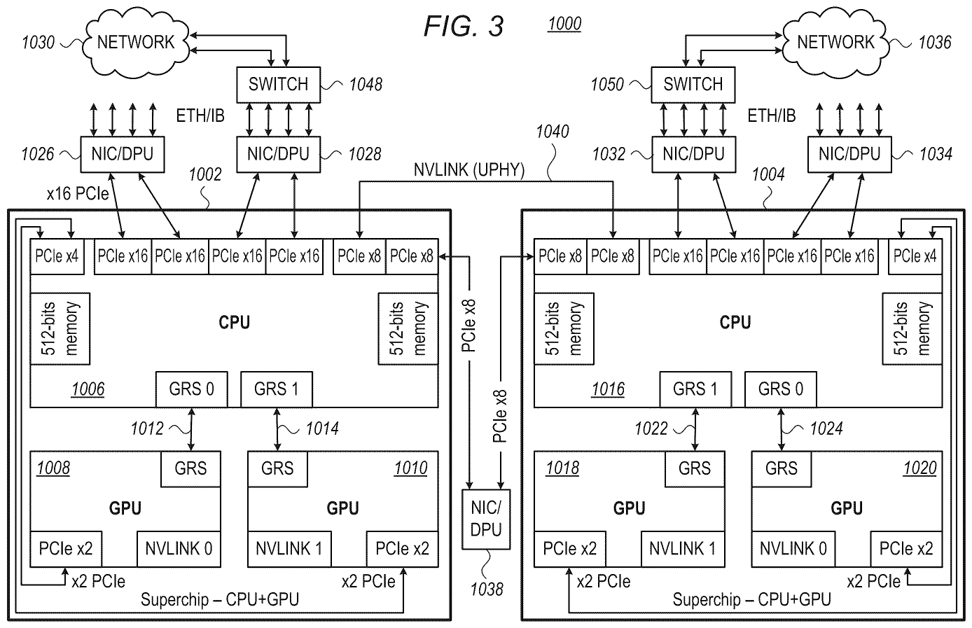

FIG. 3 is a block diagram that schematically illustrates a computing system 1000, e.g., a data center or a High-Performance Computing (HPC) cluster, which can be managed using the disclosed techniques, in an embodiment. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 3 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 3, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 3, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

The packet switches in FIG. 3 may comprise, for example, Nvidia Quantum-2 switches. The NICs/DPUs in the figure may comprise, for example, Nvidia Bluefield DPUs. In various embodiments, system 1000 can be managed using the techniques described herein. For example, system 1000 can serve as operational network 24 of FIG. 1, and be managed using management node 46, via management network 36.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network-device management apparatus, comprising:
a network interface, to communicate with a first network of a first network protocol, wherein the first network is to manage a second network of a second network protocol that is different from the first network protocol; and
a processor, to run a Network Operating System (NOS) that jointly manages network devices in both the first network and the second network.

2. The apparatus according to claim 1, wherein, as part of running the NOS, the processor is to:
run an Application Programming Interface (API) for managing the second network;
receive, via the API, a management command specified in terms of the second network or the second network protocol; and
execute the management command in the second network via the first network.

3. The apparatus according to claim 2, wherein the API hides a presence of the first network, even though the NOS manages network devices in both the first network and the second network.

4. The apparatus according to claim 2, wherein the processor is to:
translate the management command into (i) one or more first operations to be performed in one or more first network devices in the first network, and (ii) one or more second operations to be performed in the one or more second network devices in the second network; and
perform the one or more first operations and the one or more second operations.

5. The apparatus according to claim 2, wherein the management command comprises a configuration command for configuring one or more second network devices in the second network, and wherein, in response to the configuration command, the processor is to configure the one or more second network devices in the second network, and to also configure one or more first network devices in the first network.

6. The apparatus according to claim 2, wherein the management command comprises an update command, for updating software in one or more network devices in the second network, and wherein the processor is to update the software in the second network, while maintaining compatibility between the updated software and the first network.

7. The apparatus according to claim 2, wherein the management command refers to one or more network devices in the second network in terms of one or more second identifiers or addresses of the second network protocol, and wherein the processor is to:
map the one or more second identifiers or addresses to at least one first identifier or address of the first network protocol; and
route the management command via the first network using the at least one first identifier or address.

8. The apparatus according to claim 1, wherein, in response to addition of a new network device to the second network, the processor is to reconfigure the first network to forward traffic to the new network device.

9. The apparatus according to claim 1, wherein the processor is to run, as part of the NOS, (i) one or more first containers associated with the first network protocol, and (ii) one or more second containers associated with the second network protocol.

10. The apparatus according to claim 1, wherein the network devices comprise switches and/or routers.

11. A network-device management method, comprising:
communicating with a first network of a first network protocol, wherein the first network is to manage a second network of a second network protocol that is different from the first network protocol; and
running a Network Operating System (NOS) that jointly manages network devices in both the first network and the second network.

12. The method according to claim 11, wherein running the NOS comprises:
running an Application Programming Interface (API) for managing the second network;
receiving, via the API, a management command specified in terms of the second network or the second network protocol; and
executing the management command in the second network via the first network.

13. The method according to claim 12, wherein the API hides a presence of the first network, even though the NOS manages network devices in both the first network and the second network.

14. The method according to claim 12, wherein executing the management command comprises:
translating the management command into (i) one or more first operations to be performed in one or more first network devices in the first network, and (ii) one or more second operations to be performed in the one or more second network devices in the second network; and
performing the one or more first operations and the one or more second operations.

15. The method according to claim 12, wherein the management command comprises a configuration command for configuring one or more second network devices in the second network, and wherein executing the configuration command comprises configuring the one or more second network devices in the second network, and also configuring one or more first network devices in the first network.

16. The method according to claim 12, wherein the management command comprises an update command, for updating software in one or more network devices in the second network, and wherein executing the update command comprises updating the software in the second network, while maintaining compatibility between the updated software and the first network.

17. The method according to claim 12, wherein the management command refers to one or more network devices in the second network in terms of one or more second identifiers or addresses of the second network protocol, and wherein executing the management command comprises:
mapping the one or more second identifiers or addresses to at least one first identifier or address of the first network protocol; and
routing the management command via the first network using the at least one first identifier or address.

18. The method according to claim 11, and comprising, in response to addition of a new network device to the second network, reconfiguring the first network to forward traffic to the new network device.

19. The method according to claim 11, wherein running the NOS, comprises running (i) one or more first containers associated with the first network protocol, and (ii) one or more second containers associated with the second network protocol.

20. The method according to claim 11, wherein the network devices comprise switches and/or routers.
